(19) United States
(12) Patent Application Publication
(10) Pub. No.: US 2024/0062388 A1
(43) Pub. Date: Feb. 22, 2024

(54) REGIONAL SPATIAL ENHANCEMENT OF RGB-IR IMAGE

(71) Applicant: Smart Eye AB, Göteborg (SE)

(72) Inventors: Henrik LIND, Göteborg (SE); Torsten WILHELM, Göteborg (SE)

(21) Appl. No.: 18/269,085

(22) PCT Filed: Dec. 20, 2021
(86) PCT No.: PCT/EP2021/086769

§ 371 Date: Jun. 22, 2023

(30) Foreign Application Priority Data
Dec. 22, 2020 (EP) 20216578.3

(51) Int. Cl. G06T 7/246; H04N 23/84; H04N 23/11; H04N 23/12; H04N 23/56

(52) U.S. Cl. CPC G06T 7/246; H04N 23/843; H04N 23/11; H04N 23/12; H04N 23/56; G06T 2207/10024; G06T 2207/10048; G06T 2207/30201; G06T 2207/20084; G06T 2207/20081; G06T 2207/20132

(57) ABSTRACT

A method for eye tracking comprising acquiring a first image of a target area using an RGB-IR sensor during NIR illumination, the first image including a set of IR pixels containing information from IR dyes, and a set of RGB pixels containing information from red, blue and green dyes, respectively. The method further comprises identifying head tracking features and performing head tracking using the first image, identifying an eye region in the first image based on the head tracking features, performing demosaicing of the eye region using IR pixels and RGB pixels in the eye region, to form a spatially enhanced IR image of the eye region, and performing eye tracking using the spatially enhanced IR image.

With this approach, head tracking is used to identify a smaller region of the RGB-IR image, and this limited region is then processed to provide an enhanced IR image.

### FIELD OF THE INVENTION

The present invention relates to eye tracking using an RGB-IR sensor having Red, Blue, Green and Infrared dyes arranged in a modified Bayer pattern.

### BACKGROUND OF THE INVENTION

RGB-IR sensors are becoming increasingly popular for various applications, including automotive imaging. The article “Color Correction for RGB sensors with Dual-Band Filters for In-Cabin Imaging Applications” by Skorka et al., Society for Imaging Science and Technology, 2019, discusses color correction using such a CMOS RGB-IR sensor. As mentioned in the article, classical demosaicing (which is referred to as debayering in the context of a standard RGB sensor) needs to be slightly modified, in order to allow generate a full resolution image from the raw data from the CMOS sensor. Specifically, the debayering is followed by an IR subtraction. Such modified demosaicing is typically implemented in hardware, as part of the imaging pipeline of the CMOS chip.

An alternative to the demosaicing discussed by Skorka is described in the article “Learning based demosaicing and color correction for RGB-IR patterned image sensors”, by Navinprashath, et al., Society for Imaging Science and Technology, 2019. Here, a neural network is trained to provide a higher resolution RGB image (without influence from the IR pixels) given an image acquired by a RGB-IR sensor.

Also for eye-tracking applications it may sometimes be desirable to use an RGB-IR sensor, e.g. for increased versatility. In such applications, the eye tracker will preferably use an image acquired with IR illumination, in order to avoid interference from surrounding light. However, the demosaicing implemented in the sensor, e.g. of the kind discussed in Skorka's article, does not provide a high resolution IR image. The available IR image therefore limits the resolution for provision of precision eye and eye-lid tracking.

The approach discussed in Navinprashath's article allows software implemented demosaicing of the RGB-IR image. However, Navinprashath does not teach providing an enhanced IR image, which is ideally required by the eye tracking system. Also, such software processing would consume significant amounts of processing power, making it difficult to perform in real-time with available processing resources.

Consequently, there is a need for an improved eye tracking approach, taking even better advantage of available RGB-IR sensors.

### General Disclosure of the Invention

According to a first aspect of the invention, this and other objects are achieved by a method for eye tracking with a system comprising a light source configured to emit IR or near IR light and an RGB-IR sensor having Red, Blue, Green and Infrared dyes arranged in a modified Bayer pattern, the method comprising, in a first time frame, acquiring a first image of a target area using the RGB-IR sensor during illumination by the light source, the first image including a set of IR pixels containing information from the IR dyes, and a set of RGB pixels containing information from the red, blue and green dyes, respectively, identifying head tracking features and performing head tracking using the first image, identifying an eye region in the first image based on the head tracking features, performing demosaicing of the eye region using IR pixels and RGB pixels in the eye region, to form a spatially enhanced IR image of the eye region, and performing eye tracking using the spatially enhanced IR image.

According to a second aspect of the invention, this and other objects are achieved by an eye tracking system comprising a light source configured to emit IR or near IR light, an RGB-IR sensor having Red, Blue, Green and Infrared dyes arranged in a modified Bayer pattern, the sensor being configured to acquire, in a first frame, a first image of a target area using the RGB-IR sensor during illumination by the light source, the first image including a set of IR pixels containing information from the IR dyes, and a set of RGB pixels containing information from the red, blue and green dyes, respectively, a head tracking module configured to identify head tracking features and performing head tracking using the first image, a cropping unit for selecting an eye region in the first image based on the head tracking features, a demosaicing module configured to perform demosaicing of the selected eye region using IR pixels and RGB pixels in the eye region, to form a spatially enhanced IR image of the eye region, and an eye tracking module configured to perform eye tracking using the spatially enhanced IR image.

By “modified Bayer pattern” is intended a pattern described in the article “Color Correction for RGB sensors with Dual-Band Filters for In-Cabin Imaging Applications” by Skorka et al., Society for Imaging Science and Technology, 2019. This pattern is illustrated in FIG. 1, and includes alternating groups of four pixels, each group having one IR pixel, two green pixels, and a fourth pixel which is alternatingly red and blue. By “pixel” is intended a light sensor element, typically formed by a metal oxide semiconductor dye, covered by a light filter. The filter may be IR, red, green or blue. In some applications, the red, green and blue filters are also transparent to IR.

With this approach, head tracking is used to identify a smaller region of the RGB-IR image, and this limited region is then processed to provide an enhanced IR image. This means that the processing can be performed in real-time without requiring more processing power than what is already available in the system.

The IR regional demosaicing is preferably performed by applying a convolutional network to the RGB-IR image frame, where the convolutional network being trained to predict an enhanced IR-image given an RGB-IR image allowing the spatial information of all pixels including the glint to be recreated as a combination of all pixels.

It is noted that such an approach is slightly different from the approach by Navinpashath et al, where an accurate RGB image was predicted from the RGB-IR image. In the present inventive concept, an enhanced IR image is predicted by the neural network.

The convolutional network may include a plurality of layers, e.g. four layers, and may have a 3×3 kernel. Such a network has shown to be adequate for the present application. The convolutional network can be ground truth trained using pairs of IR images and RGB-IR images acquired from a set of objects.

In one embodiment, only the IR pixels are used for identifying head tracking features and performing head tracking. In another embodiment, the IR pixels and the RGB pixels are used to provide a full resolution image, which is used for identifying head tracking features and performing head tracking.

The spatially enhanced IR image may also be used for eye lid detection. The method may further comprise acquiring, in a second time frame, a second image of the target area using the RGB-IR sensor without illumination by the light source, performing demosaicing of the eye region of the second image, to form a second spatially enhanced image of the eye region, and performing eye lid detection using the second spatially enhanced image. With this approach, eye lid detection can be performed every frame.

### BRIEF DESCRIPTION OF THE DRAWINGS

The present invention will be described in more detail with reference to the appended drawings, showing currently preferred embodiments of the invention.

FIG. 1 shows one type of modified Bayer pattern of an RGB-IR sensor.

FIG. 2 shows very schematically a system according to an embodiment of the invention.

FIG. 3 shows a more detailed block diagram of the DMS and video conferencing system in FIG. 2.

FIG. 4 shows a time-line for image acquisition using the system in FIG. 2.

FIG. 5 illustrates a different control scheme suitable for a global shutter sensor with dual exposure.

### DETAILED DESCRIPTION OF PREFERRED EMBODIMENTS

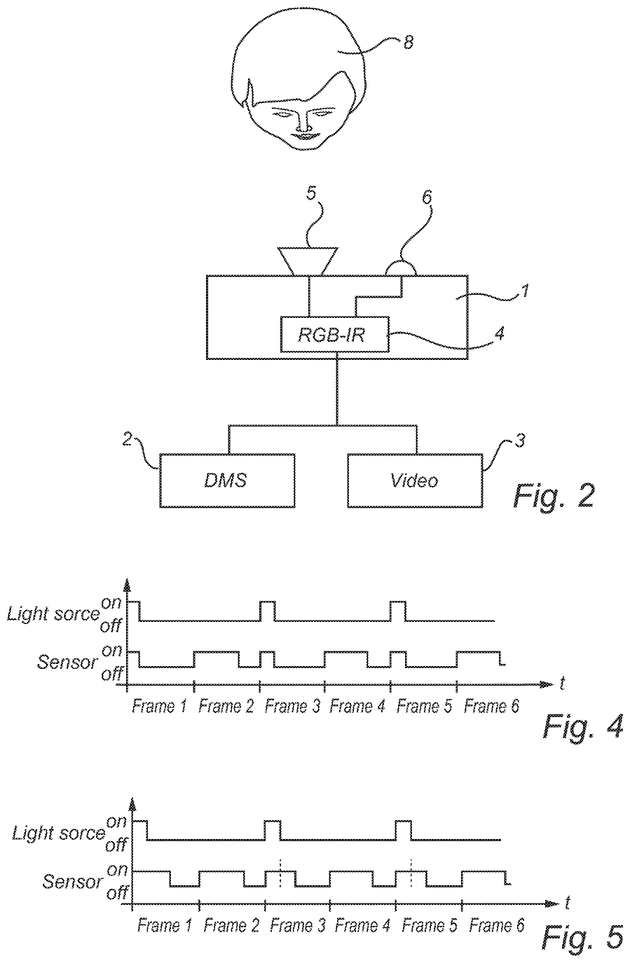

Embodiments of the present invention will be described with reference to a system as shown in FIG. 2. The system includes a camera device 1, a driver monitoring system (DMS) 2, and a video application such as a videoconferencing system 3 (or any other system requiring a color image). The camera device includes an RGB-IR image sensor 4 with associated optics 5 and a light source 6. The sensor 4 is set up by the DMS 2 and/or the video system 3 to acquire images of a required type and frame rate. The sensor 4 is connected to control the light source 6 to provide the required illumination. In the following example, the sensor will be programmed to provide images at a given frame rate (e.g. 60 Hz), where every other image (i.e. frame rate 30 Hz) is acquired with illumination by the light source 6.

The light source is configured to emit near infra-red (NIR) light, e.g. with a wavelength around 850 nm or 940 nm. For simplicity we call this IR in the rest of the document. The longer wavelength is often preferred in automobile applications, due to the lack of red glow. The light source can be configured with an additional illumination in the visible spectrum for colour video conferencing in night. During day the natural light provides this light source.

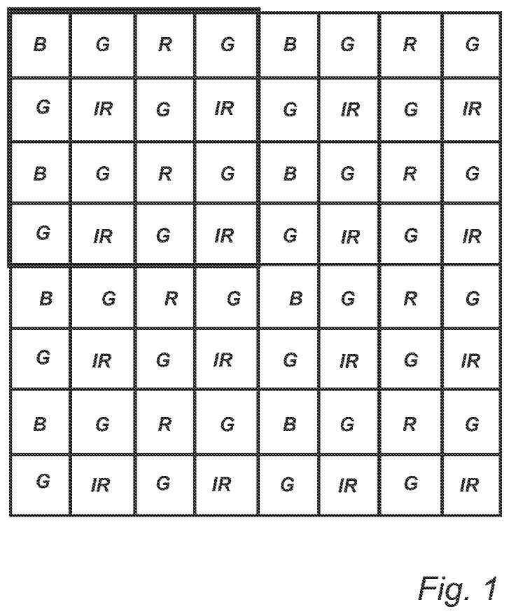

The RGB-IR sensor comprises a light sensitive sensor array, e.g. a CMOS sensor array where each pixel is a silicon photodiode. The sensor array is covered by a filter layer including red (R), green (G), blue (B) and infra-red (IR) dies, one per photosensitive pixel. The dies are typically arranged in a modified Bayer pattern, an example is shown in FIG. 1. Preferably, the RGB dies transmit also some IR light, while the IR dies do not transmit any visible RGB light. Such RGB-IR sensors are commercially available from ON Semiconductor Corp., OmniVision Technologies and others.

The RGB-IR sensor 4 may be covered by a bandpass filter configured to transmit both RGB light and IR light from the light source 5, and to block light there between. As an example, such a filter may have pass bands at approximately 370-670 nm (RGB) and 900-1000 nm (IR). This filter suppresses light with wave length of no use for the applications and allows a higher color fidelity for the video conference.

The RGB-IR sensor, depending on architecture, can be operated in at least three different ways; global shutter, global shutter with dual exposure, and rolling shutter.

In global shutter operation, all pixels of the sensor are exposed at the same time (globally). One image is acquired in each time frame, with or without IR illumination (flash). One image is preferably short with IR illumination and one image has a long exposure for use of video telephony. The second image can also be used for eye and eyelid tracking when illumination is sufficient.

In global shutter operation with dual exposure, two consecutive images are acquired in one time frame, one with and one without illumination (flash). The IR-images are then subtracted from each other, to generate an IR-image which is compensated for background illumination.

In rolling shutter operation, the rows (or columns) of the sensor are exposed sequentially in each time frame leading to a need for longer IR illumination.

In use, the device 1 is arranged in front of a user 8, e.g. a driver of a vehicle. The camera device 1 can be arranged in a vehicle (e.g. on the dash board) so that the camera device can acquire RGB-IR images of a driver 8 or the driver and passenger of the vehicle with a wide fields of view lens

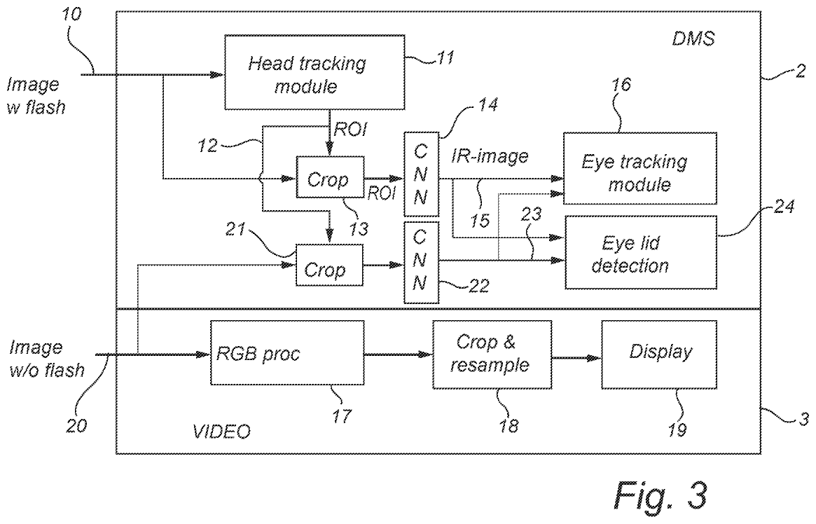

FIG. 3 shows functional block diagrams of selected parts of the DMS 2 and the video conferencing system 3.

The DMS 2 comprises a head tracking module 11, connected to receive an RGB-IR image 10 acquired by the RGB-IR sensor under illumination of the light source 6. Based on the information in the image 10, the head tracking module 11 is configured to identify head features in the image 10, and to perform head tracking based on these features. The head-tracking serves to determine the orientation of the driver's head with respect to the camera device 1 (and thus the vehicle).

In one embodiment, the information used for the head tracking is only the IR pixels of the RGB-IR image 10. In this case the head tracking will be performed on a quarter resolution. In other embodiments, a full resolution image may be used, e.g. a black/white image obtained from the RGB-IR image.

The head tracking module 11 is further configured to identify a limited area 12 of the acquired image where the eyes of the user are located. This area may be significantly smaller than the complete image 10. A cropping block 13 is configured to receive the RGB-IR image 10 and an indication of the area 12, and to crop RGB-IR pixel information of the region 12 (referred to as a “region of interest”, ROI).

The DMS 2 further comprises a convolutional neural network (CNN) 14 is trained to predict a spatially enhanced IR image 15 based on the region of interest. The CNN may include more than three layers, in the present case four layers, each with a 3×3 kernel. The CNN has been trained using ground truth data in the form of (high resolution) R-, G-, B- and IR-images acquired from an object, and a lower resolution RGB-IR image of the same object. In order to make the prediction more robust, noise may be added to the ground truth RGB-IR image.

The spatially enhanced IR image 15 is provided to an eye tracking module 16, configured to perform eye tracking. The eye tracking module may be of conventional design, and will not be described in more detail. The eye tracking module may also use the image from the block 22.

Turning now to the video system 3, it includes an RGB processing module 18, connected to receive a second RGB-IR image 20, acquired without NIR illumination. The output from the RGB-processing module is connected to a crop & resampling module 18, before being provided to a display unit 19. This processing is previously known in the art, and will not be described further herein.

In the embodiment in FIG. 3, the DMS 2 further comprises a second cropping block 21, connected to receive the second RGB-IR image 20 (without NIR illumination). The cropping block 21 also receives the area 12 from the head tracking module 11, so as to be able to output a limited region (region of interest) of the second image 20.

A second convolutional neural network (CNN) 22 is trained to predict a spatially enhanced image 23 based on the region of interest from the cropping block 21. The second CNN 22 may have the same design as the first CNN 14, and can be trained in a similar manner. In principle, it is possible to combine both CNN 14 and 22 in one single neural network, by providing suitable conditioning data as input together with the input image data.

The DMS 2 in this case also includes an eye lid detection module 24, connected to receive the spatially enhanced images 15 and 23, and perform eye lid detection. Such eye lid detection is used, for example, to determine if a driver is showing signs of drowsiness, and is known in the art.

With continued reference to FIG. 3, and also to FIG. 4, operation of this embodiment of the invention will be described. FIG. 4 illustrates activation signals (ON or OFF) 24, 26 for the RGB-IR sensor exposure 4 and the light source 6, respectively, over a series of time frames. The frame rate is typically 30-120, and often 60 Hz, but may of course be different depending on the implementation.

In a first frame, the processor 7 activates the light source 6, and simultaneously acquires an RGB-IR image with the sensor 4. This is illustrated in FIG. 4 by the signals 24 and 26 both are ON during a short duration. In the illustrated case, the duration of one frame is 16.7 ms (60 Hz), and the light source 6 and sensor 4 are active for about 100 us to1 ms.

The acquired image 10—or only the IR pixels—is provided to the head tracking module 11 of the DMS 2, and an ROI is selected by the cropping block 13 using area information 12 from the module 11. The CNN 14 then provides (predicts) a spatially enhanced IR image 15 which is used by the eye tracking module 16 to track the eyes of the driver.

In a second frame, the processor 7 controls the sensor 4 to acquire a second RGB-IR image 20, this time without NIR illumination. This is illustrated in FIG. 4 by the signal 24 being ON while the signal 26 stays OFF. The image acquisition period is typically longer in this case, e.g. around 1-10 ms.

The second image 20 is provided to the video system 3 for video processing and display.

In the present embodiment, where the DMS 2 also includes an eye lid detection module 24, in the first frame the spatially enhanced IR image 15 is also provided to the module 24 which performs eye lid detection. Further, in the second frame, the second image 20 is provided to the second cropping block 21 of the DMS 2. Based on the area information 12, the second cropping block 21 forms a second ROI, which is used as input by the second CNN 22, to predict a second spatially enhanced image 23. This second spatially enhanced image 23 is provided to the module 24 which again performs eye lid detection.

In the illustrated embodiment, the IR-based head tracking and the video display will be performed at half the frame rate (e.g. 30 Hz), as only every other frame is used for each process, respectively. However, the eye-lid detection can be performed at full frame rate (e.g. 60 Hz).

It is noted that the spatially enhanced image 23 may also be provided to the eye tracking module 16, thereby enabling also eye tracking in each frame. However, it is noted that the second image 20 is typically acquired with longer exposure time, and therefore is less sharp and may be susceptible to motion artifacts.

Further, it is noted that in principle also the second image 20 may be acquired with IR illumination. This may be advantageous, and even necessary, if the video application is intended to be functional in dark conditions. But IR illumination may also be useful in order to improve the image quality for use in modules 24 and 16.

Turning now to FIG. 5, there is illustrated a slightly different control scheme suitable for a global shutter sensor with dual exposure, as mentioned above. In this case, two separate RGB-IR images are acquired in the first frame, one with NIR illumination and one without. This is illustrated in FIG. 5 by the signal 24 having being ON twice as long as the signal 26. The two RGB-IR images are subtracted (in the sensor hardware) to provide an ambient compensated IR image. The head tracking module can now operate on this ambient compensated IR image.

The person skilled in the art realizes that the present invention by no means is limited to the preferred embodiments described above. On the contrary, many modifications and variations are possible within the scope of the appended claims. For example, the determination of a region of interest by the head tracking module might not be required in every frame, but maybe less frequently. In principle, the selected area (ROI) may also be provided by some other process instead of a head tracking module. The inventive concept is simply to perform demosaicing of a limited area of the image, thereby reducing requirements on processing capacity.

1. A method for eye tracking with a system comprising a light source configured to emit IR or near IR light and an RGB-IR sensor having Red, Blue, Green and Infrared dyes arranged in a modified Bayer pattern, the method comprising, in a first time frame:
acquiring a first image of a target area using said RGB-IR sensor during illumination by the light source, said first image including a set of IR pixels containing information from said IR dyes, and a set of RGB pixels containing information from said red, blue and green dyes, respectively,
identifying head tracking features and performing head tracking using said first image,
identifying an eye region in said first image based on the head tracking features,
performing demosaicing of the eye region using IR pixels and RGB pixels in the eye region, to form a spatially enhanced IR image of said eye region, and
performing eye tracking using said spatially enhanced IR image.

2. The method according to claim 1, wherein the step of performing demosaicing includes applying a convolutional network to said RGB-IR image frame, said convolutional network being trained to predict an enhanced IR-image given an RGB-IR image.

3. The method according to claim 2, wherein the convolutional network has a plurality of layers, preferably more than three layers, and a minimum 3×3 kernel.

4. The method according to claim 2, wherein the convolutional network has been trained using an actual IR image.

5. The method according to claim 1, wherein the red, green and blue dyes are configured to also detect infrared light.

6. The method according to claim 1, wherein only said IR pixels are used for identifying head tracking features and performing head tracking.

7. The method according to claim 1, wherein said IR pixels and said RGB pixels are used to provide a full resolution image, said full resolution image used for identifying head tracking features and performing head tracking.

8. The method according to claim 1, further comprising performing eye lid detection using said spatially enhanced IR image.

9. The method according to claim 1, further comprising:
acquiring, in a second time frame, a second image of the target area using said RGB-IR sensor without illumination by said light source,
identifying an eye region in said second image based on the head tracking features,
performing demosaicing of said eye region of said second image, to form a second spatially enhanced image of said eye region, and
performing eye lid detection using said second spatially enhanced image.

10. An eye tracking system comprising:
a light source configured to emit IR or near IR light;
an RGB-IR sensor having Red, Blue, Green and Infrared dyes arranged in a modified Bayer pattern, said sensor being configured to acquire, in a first frame, a first image of a target area using said RGB-IR sensor during illumination by the light source, said first image including a set of IR pixels containing information from said IR dyes, and a set of RGB pixels containing information from said red, blue and green dyes, respectively;
a head tracking module configured to identify head tracking features and performing head tracking using said first image;
a cropping unit for selecting an eye region in said first image based on the head tracking features;
a demosaicing module configured to perform demosaicing of the selected eye region using IR pixels and RGB pixels in the eye region, to form a spatially enhanced IR image of said eye region; and
an eye tracking module configured to perform eye tracking using said spatially enhanced IR image.

11. The system according to claim 10, wherein the demosaicing unit includes a convolutional network trained to predict an enhanced IR-image given an RGB-IR image.

12. The system according to claim 10, wherein
the red, green and blue dyes are configured to also detect infrared light.

13. The system according to claim 10, wherein said system further comprises an eye lid detection module configured to perform eye lid detection using said spatially enhanced IR image.

14. The system according to claim 13,
wherein the sensor is further configured to acquire, in a second time frame, a second image of the target area using said RGB-IR sensor without illumination by said light source, and:
wherein said demosaicing unit is configured to identify an eye region in said second image based on the head tracking features, and perform demosaicing of said eye region of said second image, to form a second spatially enhanced image of said eye region, and
wherein said eye lid detection module is further configured to perform eye lid detection using said second spatially enhanced image.

15. The system according to claim 10, wherein the sensor is one of a global shutter sensor and a rolling shutter sensor.
